(19) United States
(12) Patent Application Publication
(10) Pub. No.: US 2002/0034081 A1
(43) Pub. Date: Mar. 21, 2002

(54) Vehicle lamp

(75) Inventor: Tomoaki Serizawa, Shizuoka (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: KOITO MANUFACTURING CO., LTD.

(21) Appl. No.: 09/953,943

(22) Filed: Sep. 18, 2001

(30) Foreign Application Priority Data
Sep. 18, 2000 (JP) P. 2000-281456

(51) Int. Cl. F21V 21/00

(52) U.S. Cl. 362/540; 362/543; 362/545

(57) ABSTRACT

A vehicle lamp having a light source formed from a plurality of LEDs. The vehicle lamp has a plurality of Fresnel lenses for converting light from the LEDs to parallel light, and are provided in front of the light source. A diffusion lens having a plurality of diffusion lens elements is provided in front of the plurality of Fresnel lenses. The vehicle lamp also has a condenser lens that receives light from the plurality of diffusion lens, and the condenser lens is provided in front of the diffusion lens. Light from each LED is converted to parallel light, diffused by the diffusion lens and then concentrated by the condenser lens before being emitted in the forward direction of the lighting device. The maximum diffusion angle and luminous intensity distribution of the forward emission light of the lighting device can readily be set at target values by properly adjusting the shapes of the respective diffusion lens elements and the condenser lens. Moreover, luminosity of the whole light source can be made substantially uniform over a broad luminescent area.

### BACKGROUND OF THE INVENTION

1. Technical Field of the Invention

The present invention relates to a vehicle lamp comprising a light source having a plurality of LEDs (light emitting diodes).

2. Prior Art

Conventional incandescent bulbs (e.g., filament bulbs) have been used as light sources in a number of vehicle lamps. However, vehicle lamps using a plurality of LEDs as light sources have been used in recent years in order to reduce power consumption and provide the vehicle lamps with a novel design.

Notwithstanding the advantages of LEDs, the problem is that simply using a plurality of LEDs as a light source is unfit for making the light source look like a single light source. In addition, it is not easy to obtain required luminous intensity distribution performance of the lighting device when using a plurality of LEDs.

### BRIEF SUMMARY OF THE INVENTION

An object of the present invention is to provide a vehicle lamp comprising a light source having a plurality of LEDs, wherein the light source appears as a single light source when the light source is turned on, and wherein the required luminous intensity distribution performance of the lighting device is readily obtainable.

In other words, a vehicle lamp according to the invention comprises a light source having a plurality of LEDs, wherein a plurality of Fresnel lenses for converting light from the LEDs to parallel light are provided in front of the light source. The vehicle lamp further comprises a diffusion lens, having a plurality of diffusion lens elements, provided in front of the plurality of Fresnel lenses. The vehicle lamp further comprises a condenser lens is provided in front of the diffusion lens. The arrangement of component members other than the light source, the plurality of Fresnel lenses, the diffusion lens and the condenser lens in the light source of the vehicle lamp is not limited to any specific arrangement.

As long as the light source is composed of the plurality of LEDs, the luminescent color and disposition of each LED are not limited to any specific arrangement.

As described above, the vehicle lamp according to the present invention comprises the light source having the plurality of LEDs wherein the plurality of Fresnel lenses for converting light from each LED to parallel light are provided in front of the light source. The diffusion lens having the plurality of diffusion lens elements is provided in front of the Fresnel lenses. The condenser lens is provided in front of the diffusion lens, so that the following operation is obtainable.

Light from each LED is passed through the Fresnel lenses for converting the light to parallel light. The parallel light is passed through the diffusion lens for diffusion. Next, the diffused light passes through the condenser lens for concentration and to emit the light forward from the lighting device. Consequently, the maximum diffusion angle and luminous intensity distribution of the forward emission light of the lighting device can readily be set at target values by properly adjusting the shapes of the respective diffusion lens elements constituting the diffusion lens and the condenser lens. Moreover, the luminosity of the whole light source can be made substantially uniform over a broad luminescent area because of the diffusive action of the diffusion lens.

Therefore, in the vehicle lamp comprising a light source having the plurality of LEDs according to the present invention, the light source can appear like a single light source when the light source is turned on. In addition, the required luminous intensity distribution performance of the lighting device can readily be obtainable.

Further, as the diffusion lens and the plurality of Fresnel lenses are provided between the condenser lens and the light source, the light source is prevented from looking magnified by the condenser lens when the lighting device is observed from the forward direction while the lighting device is not lighted.

Moreover, the formation of one light emitting unit with the light source, the plurality of Fresnel lens units, the diffusion lens and the condenser lens allows the quantity of light of the lighting device to be increased. In addition, a novel lighting device design can be created by properly disposing the light emitting unit in a plurality of places.

At this time, the provision of a plurality of light emitting units at predetermined intervals on the substantially same circumference of a circle can provide an integrated design the whole lighting device.

In addition, the formation of the cylindrical portion extending towards each condenser lens while the outer peripheral shape of the opening portion is substantially maintained in the opening portion of the dome-shaped panel. The application of a mirror reflection process to the inner peripheral surface of the cylindrical portion allows light obliquely emitted from the light emitting unit and incident on the inner peripheral surface of the forward cylindrical portion to be utilized as light for irradiating the side of the lighting device. This obliquely emitted light can be used because the light is reflected from the inner peripheral surface.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIG. 1 is an elevation view of a vehicle lamp according to an embodiment of the present invention;

FIG. 2 is a side sectional view of the vehicle lamp according to an embodiment of the present invention;

FIG. 3 is a horizontal sectional view of the vehicle lamp according to an embodiment of the present invention;

FIG. 4 is an elevation view showing an arrangement of light emitting units of the vehicle lamp in detail;

FIG. 5 is a sectional view taken on line V-V of FIG. 4;

FIG. 6 is an elevation view showing a state when the vehicle lamp is turned on; and

FIG. 7 is an elevation view showing a state when the vehicle lamp is turned off.

### DETAILED DESCRIPTION OF THE INVENTION

Referring now to the drawings, an embodiment of the present invention will be described.

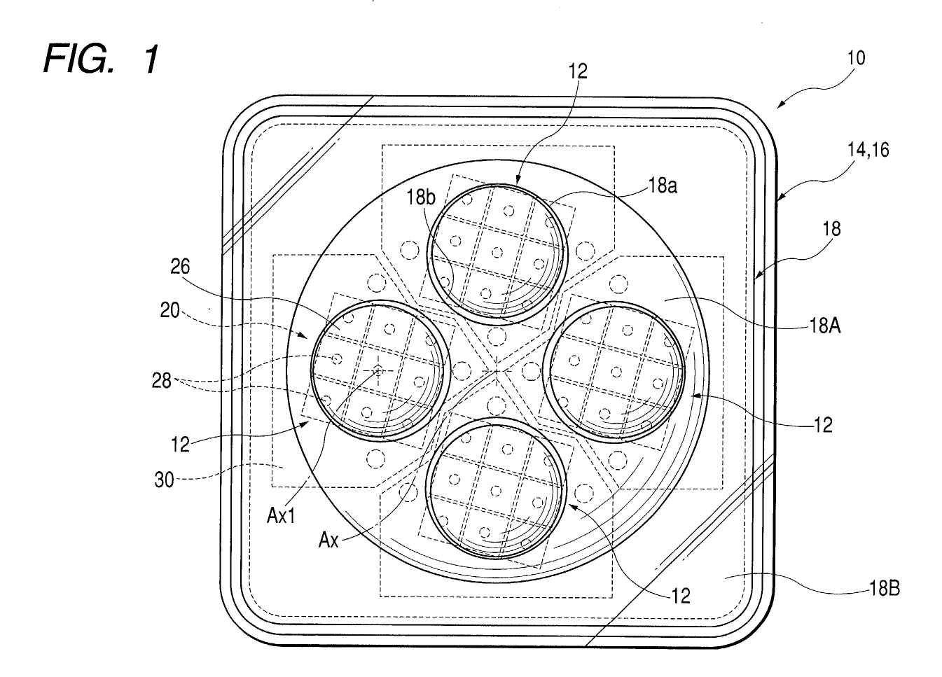

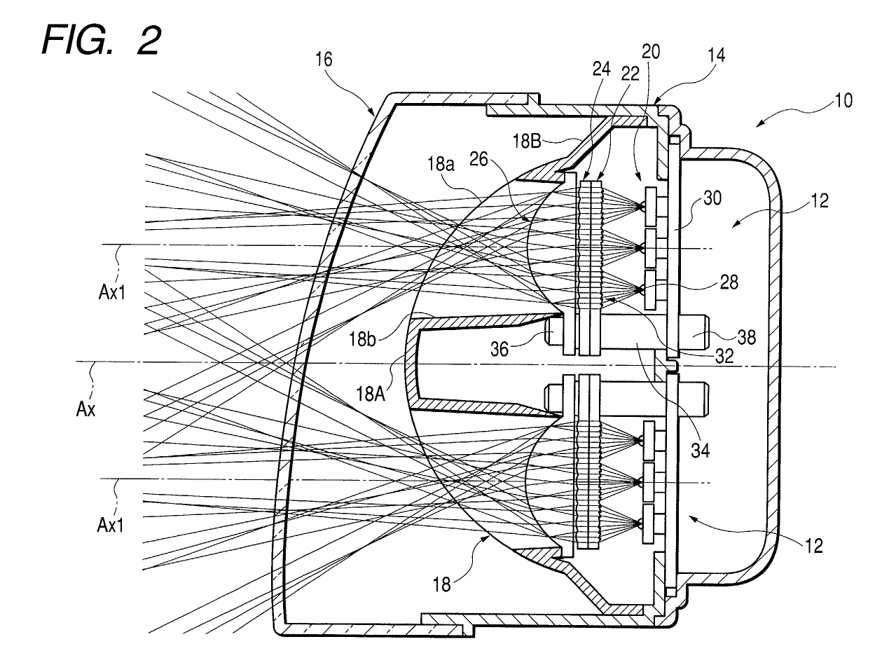

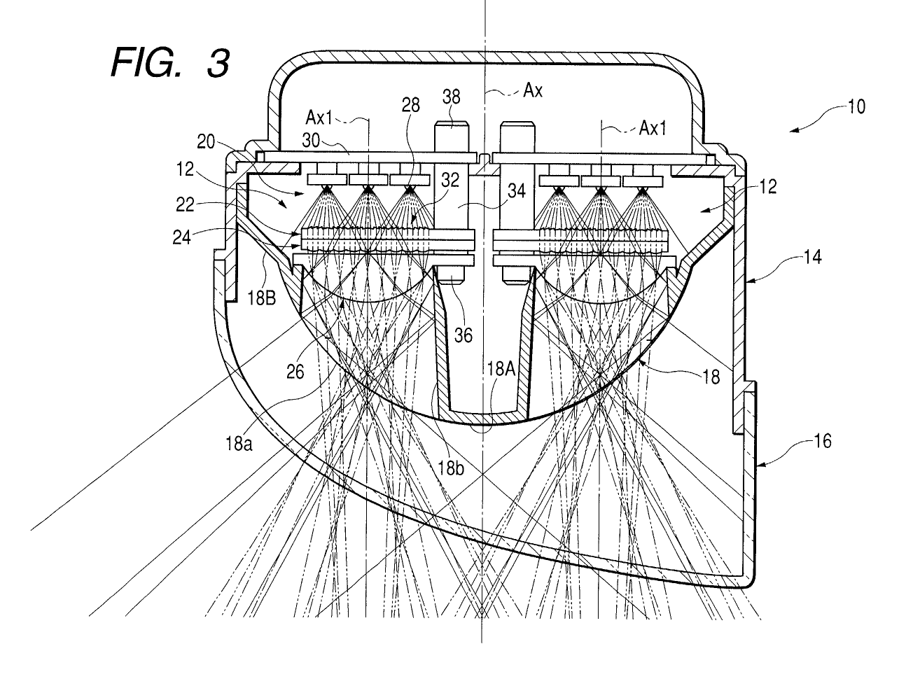

FIG. 1 is an elevation view of a vehicle lamp embodying the present invention, and FIGS. 2 and 3 are a side sectional view and a horizontal sectional view thereof, respectively.

As shown in these drawings, a vehicle lamp 10 according to the present invention is a front turn-signal lamp that is provided in the right-side front-end portion of a vehicle. The vehicle lamp 10 comprises four light emitting units 12 and a dome-shaped panel 18 in front of the light emitting units 12. The light emitting units 12 and the dome-shaped panel 18 are disposed in a lamp chamber formed with a lamp body 14. The lamp body 14 has a substantially square contour in the elevation view of the lighting device and a see-through translucent cover 16.

Each of the light emitting units 12 has an optical axis Ax1 extending in parallel to the longitudinally-extended optical axis Ax of the vehicle lamp 10. The light emitting units 12 are disposed crosswise at 90° intervals on the same circumference centering on the optical axis Ax. These light emitting units 12 are fixed to the lamp body 14.

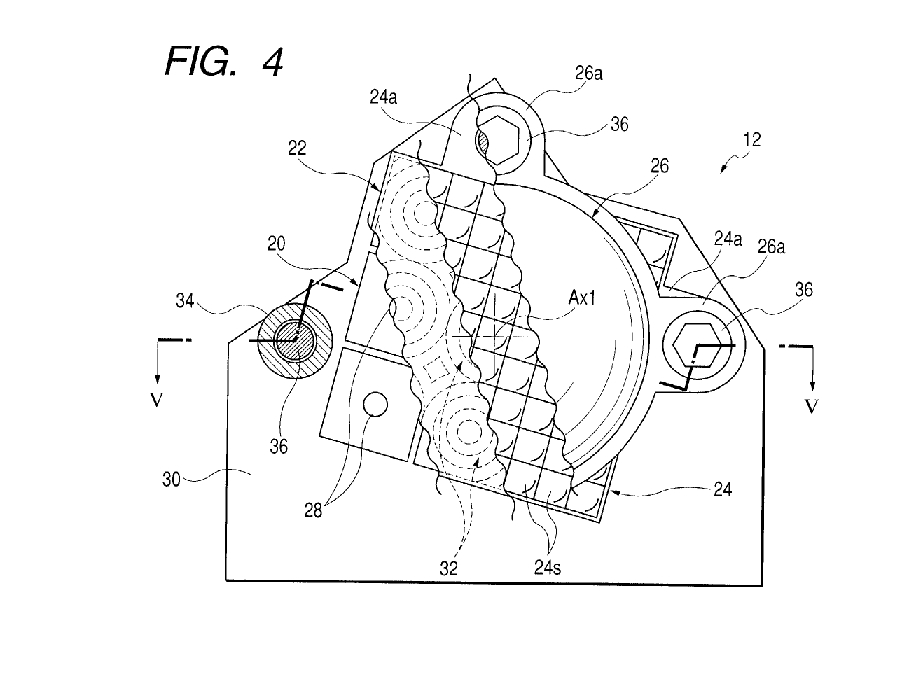

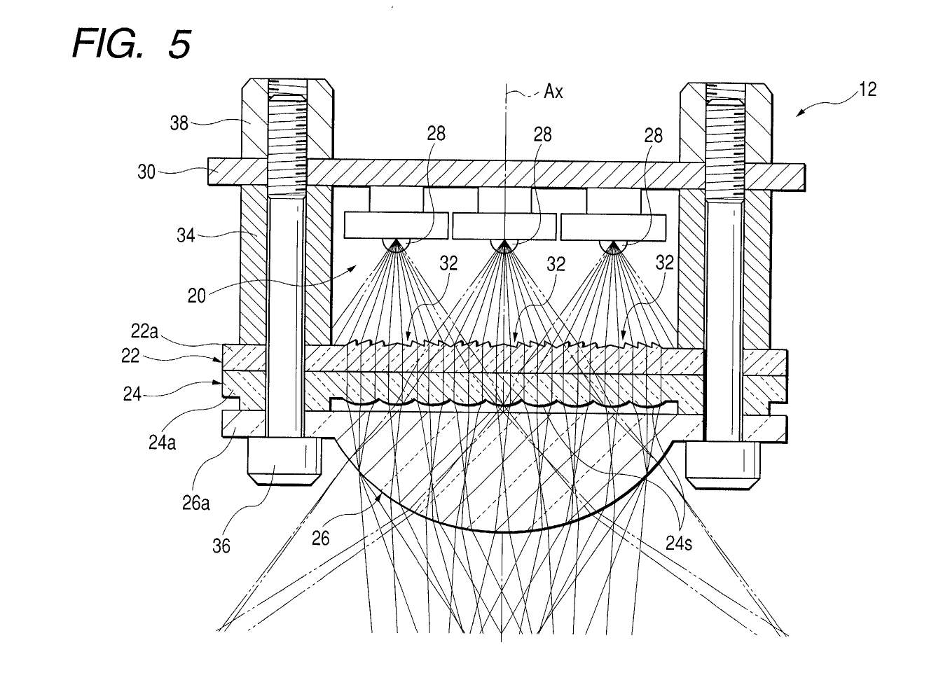

FIG. 4 is an elevation view showing an arrangement of the light emitting units 12 in detail, and FIG. 5 a sectional view taken on line V-V of FIG. 4.

As shown in these drawings, each of the light emitting units 12 comprises a light source 20, a Fresnel lens unit 22, a diffusion lens 24 provided in front of the Fresnel lens unit 22, and a condenser lens 26 provided in front of the diffusion lens 24.

The light source 20 has nine LEDs 28 mounted on a printed board 30. These LEDs are amber LEDs disposed such that the amber LEDs are vertically and horizontally disposed in the form of a square around the optical axis Ax1, e.g., a 3×3 square. The Fresnel lens unit 22 includes Fresnel lenses 32 formed on the rear faces in positions corresponding to the respective nine LEDs 28. Light from each LED 28 is converted by each Fresnel lens 32 to light parallel to the optical axis Ax1. The diffusion lens 24 includes a plurality of diffusion lens elements 24s in the form of a fish-eye lens. The condenser lens 26 is a planoconvex lens having a convex surface on the front side.

The Fresnel lens unit 22, the diffusion lens 24 and the condenser lens 26 are fixed to the printed board 30 with bolts 36 and nuts 38 via spacers 34 in the outer peripheral places 22a, 24a and 26a formed in the several peripheral places. This forms one light emitting unit 12. At this time, the length of each spacer 34 is set as shown by the chain double-dashed lines in FIG. 5. Thus, light from each LED 28 may be incident in a range slightly wider than the Fresnel lens 32 positioned in front of the LED 28 with respect to the Fresnel lens unit 22.

Referring to FIG. 1, four of the light emitting units 12 are disposed crosswise. In each light source 20, the square formed by the nine LEDs 28 is tilted by approximately 15° in order that the light emitting units 12 are disposed in a relationship with each other in a position close to the optical axis Ax. Further, each of the printed boards 30 has an edge face having a complicated irregular shape toward the optical axis so as to avoid making the adjoining printed boards 30 interfere with each other.

As shown in FIGS. 1-3, the dome-shaped panel 18 is composed of a dome portion 18A protruding forward and a skirt portion 18B positioned around the dome portion 18A, the outer peripheral edge portion of the skirt portion 18B being fixed to the lamp body 14. A circular opening portion 18a that is slightly larger in diameter than the condenser lens 16 in the elevation view of the lighting device is formed in the dome-shaped panel 18A in front of each light source 20. In the opening portion 18a lies a cylindrical portion 18b extending backward up to the vicinity of the condenser lens 26 while substantially maintaining the outer peripheral shape of the opening portion 18a. A mirror reflection process is applied to the surfaces of the dome portion 18A and the skirt portion 18B. Moreover, the mirror reflection process is also applied to the inner peripheral surface of each cylindrical portion 18b.

The following light emission is carried out in each light emitting unit 12.

As shown by a solid line in FIG. 5, light from each of the LEDs 28 constituting the light source 20 passes through the Fresnel lens 32 positioned in front of the light source 20 and reduced to parallel light. Then, the light passes through the diffusion lens 24 and is diffused. The diffused light passes through the condenser lens 26 and is concentrated, and then the light is emitted forward from the light emitting unit 12. The light is diffused vertically and horizontally at a predetermined angle centering on the optical axis Ax1.

As shown by the chain double-dashed lines in FIG. 5, light incident from each LED 28 on the Fresnel lens 22 positioned obliquely in front of the LED 28 is emitted forward from the light emitting unit 12 at a large angle with respect to the optical axis Ax1.

The light emission from each light emitting unit 12 of the vehicle lamp 10 is carried out as follows.

As shown by solid lines in FIG. 2 and chain double-dashed lines in FIG. 3, light incident on the Fresnel lens 32 positioned in front of each LED 38 in each light emitting unit 12 is formed into forward emitted light. This light is directly passed through the each opening portion 18a of the dome-shaped panel 18 and emitted forward.

On the other hand, as shown by solid lines in FIG. 3, light incident from each LED 28 on the Fresnel lens 32 positioned obliquely in front of the LED 28 is emitted forward from the light emitting unit 12 at a large angle with respect to the optical axis Ax1. Thus, the greater part of the light is incident on the cylindrical portion 18b of the dome portion 18A. As described above, a mirror reflection process was been applied to the inner peripheral surface of the cylindrical portion 18b. The light incident on the cylindrical portion 18b is reflected from the inner peripheral surface of the cylindrical portion 18b before being emitted forward at a large angle with respect to the optical axis Ax.

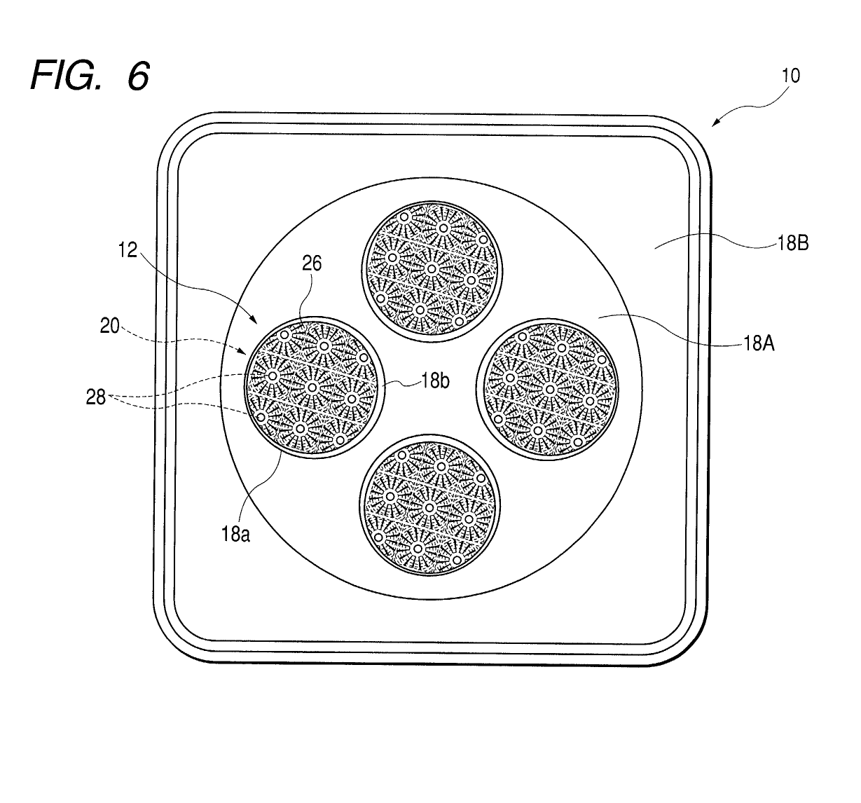

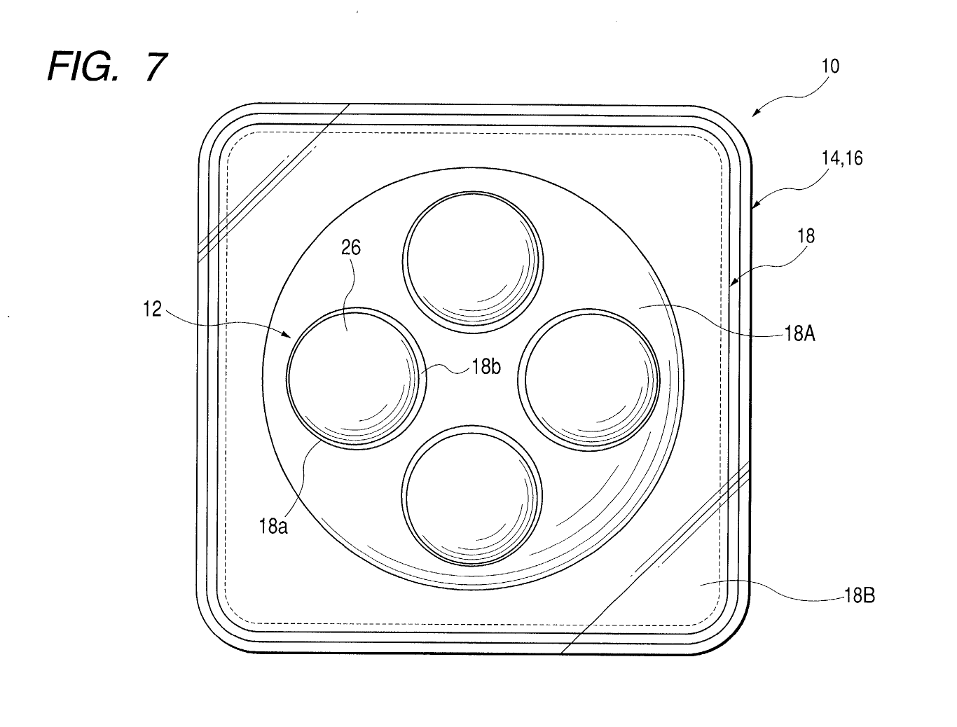

FIGS. 6 and 7 are elevation views showing a state in which the vehicle lamp 10 is turned on and a state in which the vehicle lamp 10 is turned off according to the this embodiment of the present invention, respectively.

As shown in FIG. 6, each vehicle lamp 12 looks luminous via four opening portions disposed crosswise in the dome-shaped panel 18 around the optical axis Ax when the vehicle lamp 12 is turned on. Although the light source 20 is constituted of the nine LEDs 28 at that time, the luminosity of the whole light source 20 looks substantially uniform because of the diffusive action of the diffusion lens 24. When the vehicle lamp 10 is observed from an oblique direction, the light reflected from the cylindrical portion 18b of the dome-shaped panel 18 is also visible.

As shown in FIG. 7, the dome portion 18A and skirt portion 18B of the dome-shaped panel 18 look luminous in a whitish fashion because of the external light reflective action of the dome portion 18A and the skirt portion 18B. Moreover, the surface of the condenser lens 26 positioned inside each of the four opening portions formed crosswise looks slightly dark. The surface of each condenser lens 26 is dome-shaped similar to the dome portion 18A of the dome-shaped panel 18. Thus, four small cross-shaped transparent domes can be seen in the dome-shaped panel 18, and an integrated design is obtained. In addition, since the mirror reflection process was applied to the cylindrical portion of the dome-shaped panel 18, there is provided a design with contrast between the four condenser lenses 26 and their surrounding being emphasized.

As set forth above, the vehicle lamp 10, according to this embodiment of the present invention, comprises the light source 20 having the plurality of LEDs 28. The plurality of Fresnel lenses 32 that convert light from each LED 28 to parallel light are provided in front of the light source 20. The diffusion lens 24 comprising a plurality of diffusion lens elements 24 is provided in front of the plurality of Fresnel lenses 32. The condenser lens 26 is provided in front of the diffusion lens 24.

Light from each LED passes through the Fresnel lenses 32 that convert the light to parallel light. The converted light then passes through the diffusion lens 24 for diffusion. The diffused light then passes through the condenser lens 26 and is concentrated. The concentrated light is then emitted forward from the lighting device as diffused light. Consequently, the maximum diffusion angle and luminous intensity distribution of the forward emission light of the lighting device can readily be set at target values by properly adjusting the shapes of the respective diffusion lens elements 24 constituting the diffusion lens 24 and the condenser lens 26. Moreover, the luminosity of the whole light source 28 can be made substantially uniform over a broad luminescent area because of the diffusive action of the diffusion lens 24.

Therefore, in the vehicle lamp according to this embodiment of the present invention, the light source can look like a single light source when the light source is turned on. In addition, the required luminous intensity distribution performance of the lighting device can be obtained.

Due to the diffusion lens 24 and the plurality of Fresnel lenses 32 provided between the condenser lens 26 and the light source 20, the light source is prevented from appearing to be magnified by the condenser lens 26. This effect is achieved when the unlighted lighting device is observed from the forward direction.

The light source 20, the Fresnel lens units 22, the diffusion lens 24 and the condenser lens 26 form one light emitting unit 12. Four of the light emitting units 12 are disposed, according to this embodiment of the present invention, to increase the quantity of light of the lighting device and to create a novel lighting device design. As these light emitting units 12 are disposed crosswise at 90° intervals on the same circumference centering on the optical axis Ax at this time, an integrated design in terms of design-making can be provided for the whole lighting device.

As the dome-shaped panel 18 formed with the opening portion 18a in the front portion of the condenser lens 26 of each of the light emitting units 12 is provided in front of the four light emitting units 12, a novel design can be provided for the lighting device.

In addition, the cylindrical portion 18b extends towards each condenser lens 26, while the outer peripheral shape of the opening portion 18a is substantially maintained in the opening portion 18a of the dome-shaped panel 18. The mirror reflection process is applied to the inner peripheral surface of the cylindrical portion 18b. Light that is obliquely emitted from the light emitting unit 12 and incident on the inner peripheral surface of the forward cylindrical portion 18b becomes utilizable as light for irradiating the side of the lighting device. In other words, light reflected from the inner peripheral surface can be used for irradiating the side of the lighting device. Therefore, anyone who observes the lighting device from a substantially oblique direction beside the lighting device is made to recognize the fact that the lighting device is lighted, whereby the lighting device functions as a front turn-signal lamp.

Although the vehicle lamp 10 according to this embodiment of the present invention is a front turn-signal lamp, the same operation and working effect can be obtained by adopting the same arrangement as described in this embodiment thereof for other kinds of vehicle lamps.

The foregoing description of an embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated.

What is claimed is:

1. A vehicle lamp comprising a light source having a plurality of LEDs, and further comprising:
a plurality of Fresnel lenses provided in front of said light source;
a diffusion lens having a plurality of diffusion lens elements, said diffusion lens provided in front of said plurality of Fresnel lenses; and
a condenser lens provided in front of said diffusion lens.

2. The vehicle lamp as claimed in claim 1, wherein said light source, said plurality of Fresnel lenses, said diffusion lens and said condenser lens comprise a single light emitting unit.

3. The vehicle lamp as claimed in claim 2, wherein a plurality of light emitting units are provided at predetermined intervals on the circumference of a circle.

4. The vehicle lamp as claimed in claim 3, wherein a dome-shaped panel having an opening portion is provided in the front portion of each light emitting unit among said plurality of light emitting units.

5. The vehicle lamp as claimed in claim 4, wherein each opening portion in said dome-shaped panel comprises a cylindrical portion extending towards each condenser lens of each light emitting unit while maintaining the outer peripheral shape of said opening portion.

6. The vehicle lamp as claimed in claim 5, wherein the inner peripheral surface of each of the cylindrical portions in said dome-shaped panel is mirror reflection processed.

7. The vehicle lamp as claimed in claim 1, wherein said plurality of LEDs are mounted on a plurality of printed boards, and each of said printed boards has an edge face having an irregular shape.

8. The vehicle lamp as claimed in claim 1, wherein each of said plurality of diffusion lens elements comprises a fish-eye lens.

9. The vehicle lamp as claimed in claim 1, wherein said condenser lens is a planoconvex lens having a convex surface on a side facing away from said diffusion lens.

10. A vehicle lamp comprising a light source having a plurality of LEDs that emit light, and further comprising:
a plurality of Fresnel lenses that convert light from said light source to parallel light;
a diffusion lens having a plurality of diffusion lens elements, said diffusion lens diffusing the parallel light from said plurality of Fresnel lenses; and
a condenser lens that concentrates the diffused light from said diffusion lens.

11. The vehicle lamp as claimed in claim 10, wherein said plurality of Fresnel lenses, said diffusion lens and said condenser lens are provided along an optical axis of said light source.

12. The vehicle lamp as claimed in claim 10, wherein said light source, said plurality of Fresnel lenses, said diffusion lens and said condenser lens comprise a single light emitting unit.

13. The vehicle lamp as claimed in claim 12, wherein a plurality of light emitting units are provided at predetermined intervals on the circumference of a circle.

14. The vehicle lamp as claimed in claim 13, wherein a dome-shaped panel having an opening portion is provided in a front portion of each light emitting unit among said plurality of light emitting units.

15. The vehicle lamp as claimed in claim 14, wherein each opening portion in said dome-shaped panel comprises a cylindrical portion extending towards each condenser lens of each light emitting unit.

16. The vehicle lamp as claimed in claim 15, wherein the inner peripheral surface of each of the cylindrical portions in said dome-shaped panel is mirror reflection processed.

17. The vehicle lamp as claimed in claim 10, wherein each of said plurality of diffusion lens elements comprises a fish-eye lens.

18. The vehicle lamp as claimed in claim 10, wherein said condenser lens is a planoconvex lens having a convex surface on a side facing away from said diffusion lens.

19. A vehicle lamp comprising a light source having a plurality of LEDs that emit light, and further comprising:
a plurality of Fresnel lenses that convert light from said light source to parallel light;
a diffusion means for diffusing the parallel light from said plurality of Fresnel lenses; and
a condenser means for condensing the diffused light from said diffusion lens.

20. The vehicle lamp as claimed in claim 19, wherein said plurality of Fresnel lenses, said diffusion mean and said condenser means are provided along an optical axis of said light source.
